(19) United States
(12) Patent Application Publication
(10) Pub. No.: US 2007/0164921 A1
(43) Pub. Date: Jul. 19, 2007

(54) Broadband antenna apparatus

(75) Inventors: Chuan-Lin Hu, Sijhih City (TW); Chang-Fa Yang, Taipei City (TW); Shun-Tian Lin, Taipei City (TW); Chang-Lun Liao, Sijhih City (TW); Yu-Wei Chen, Sijhih City (TW); Yen-Ming Chen, Taipei City (TW); Chao-Wei Wang, Taipei City (TW)

Correspondence Address: BIRCH STEWART KOLASCH & BIRCH, PO BOX 747, FALLS CHURCH, VA, 22040-0747, US

(73) Assignee: Chant Sincere Co., Ltd.

(21) Appl. No.: 11/588,251

(22) Filed: Oct. 27, 2006

(30) Foreign Application Priority Data
Nov. 1, 2005 (TW) 94138314

(51) Int. Cl. H01Q 1/36

(52) U.S. Cl. 343/895

(57) ABSTRACT

This disclosure relates to a broadband antenna apparatus having single or multiple winding strips. The broadband antenna apparatus has a dielectric material layer, and the single or multiple winding strips surround one another over the dielectric material layer. An antenna feed is located on the single or multiple winding strips, and ground terminals can be added.

### RELATED APPLICATIONS

The present application is based on, and claims priority from, Taiwan Application Serial Number 94138314, filed Nov. 1, 2005, the disclosure of which is hereby incorporated by reference herein in its entirety.

### BACKGROUND OF THE INVENTION

1. Field of Invention

The invention relates to an antenna apparatus and, in particular, to a broadband antenna apparatus having single or multiple winding strips.

2. Related Art

As multimedia wireless transmissions become more popular, the transmission bandwidth is an important factor to be considered in the wireless communication technology. From the considerations of real-time, high bandwidth, and power-saving properties of media streaming, the widely used wireless transmission standards such as Bluetooth and wireless fidelity (WiFi) still cannot satisfy the market needs.

Therefore, the wireless communication industry has set an ultra wide band (UWB) wireless transmission standard. It has the advantages of a large bandwidth and low power consumption. A transmission speed up to 500 Mbps can be achieved within the range of one meter. It is therefore particularly suitable for high-quality wireless communication services, such as digital home electronics, data exchanges between wireless products and a host computer (e.g., multiple frequency-band network bridge, audio/video streaming of high resolution digital TVs), wireless digital video cameras, and mobile communication devices.

The antenna is the window for transmitting and receiving electromagnetic (EM) waves. It has to be specially designed so that it can effectively radiate the radio energy into space or intercept EM energy in space and convert it into useful radio signals. The quality of an antenna design almost completely determines the performance of the entire communication equipment. It is therefore of great consequence to design a practical antenna that satisfies the communication standards. The performance of the above-mentioned UWB products is greatly affected by their antennas.

Take an ultra high frequency (UHF) digital TV antenna as an example. Currently it still uses the conventional extending monopole antenna. Such antennas have such a narrow working band that they cannot satisfy the wide-band requirement of the UHF digital TV in its full frequency range (470 MHz˜860 MHz). Moreover, they have an effect on the overall appearance of the devices, and even make wind-shear and other noises when they are installed on a moving transportation tool (e.g., a vehicle).

In the following, we take a couple of relevant patents related to digital TV antennas to explain what drawbacks or shortcomings exist in circuit design and manufacturing of the digital TV antenna in the prior art.

(1) TW Utility Model Patent. No. M269,583:

This patent proposed a digital TV antenna for receiving digital TV signals. The interior of the digital TV antenna is disposed in sequence a lower copper tube, an upper copper tube, and a spring receiver. After the assembly, the upper portion of the spring receiver and the signal line inside the digital TV antenna are soldered together. The cross-sectional area between the lower copper tube, the upper copper tube and the spring receiver and the soldering position between the upper portion of the spring receiver and the signal line are adjusted to reach the required frequency for the digital TV antenna. However, this type of antenna is the monopole antenna. It has a larger size and limited applications.

(2) TW Patent Post-Granted Pub. No. 521,455:

This patent proposes a flat miniaturized antenna for digital TVs. The antenna includes a substrate and several antennas. The upper and lower surfaces of the substrate are formed with strip lines by copper foil printing. A connector is disposed at the center of the strip line on the lower surface. A feeding line penetrates through and connects the upper and lower surfaces of the substrate. Both sides of the strip line are extended in the perpendicular direction with several electrically coupled line-shaped antennas, distributed in the second and fourth quadrants of each surface of the substrate. Each quadrant has three sets of antennas disposed in parallel. The length of the outer antenna is larger than that of the inner one. The antennas in the second and fourth quadrants are disposed with mirror symmetry. Several cracks are formed at places where each set of antennas are close to the strip line, generating capacitor couplings for LC resonance and thereby obtaining wide frequency bands. However, the miniaturized antenna thus obtained still has a large size for the required wide band, not suitable for modem applications.

### SUMMARY OF THE INVENTION

An objective of the invention is to provide a broadband antenna apparatus that uses single or multiple winding strips to achieve multiple and wide frequency bands and reduce the antenna size.

According to a preferred embodiment of the invention, the broadband antenna apparatus includes a dielectric material layer and single or multiple winding strips surrounding one another over the dielectric material layer. An antenna feed and ground terminals are located on the single or multiple winding strips.

Another objective of the invention is to provide a broadband antenna apparatus with at least two single or multiple winding strip sets stacked together. It can change the working frequency band of the antenna, increase the bandwidth, or reduce the antenna size. Moreover, the production cost can be reduced.

According to another embodiment of the invention, the broadband antenna apparatus includes a dielectric material layer and multiple winding strips surrounding one another over-the dielectric material layer. Its antenna feed and ground terminals are located on the multiple winding strips. The first winding strip set has at least two winding strips surrounding each other over one surface of the dielectric material layer. The second winding strip set has at least two winding strips surrounding each other over the other surface of the dielectric material layer. The first winding strip set is connected to the second winding strip set.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1A schematically shows the first embodiment of the invention;

FIG. 1B shows frequency response for the antenna return loss of the broadband antenna apparatus in FIG. 1A;

FIG. 2A schematically shows the second embodiment of the invention;

FIG. 2B shows frequency response for the antenna return loss of the broadband antenna apparatus in FIG. 2A;

FIG. 3A schematically shows the third embodiment of the invention;

FIG. 3B shows frequency response for the antenna return loss of the broadband antenna apparatus in FIG. 3A;

FIG. 4A schematically shows the fourth embodiment of the invention;

FIG. 4B shows frequency response for the antenna return loss of the broadband antenna apparatus in FIG. 4A;

FIG. 5A schematically shows the front surface in the fifth embodiment of the invention;

FIG. 5B schematically shows the back surface in the fifth embodiment of the invention; and

FIG. 5C shows frequency response for the antenna return loss of the broadband antenna apparatus in FIGS. 5A and 5B.

### DETAILED DESCRIPTION OF THE INVENTION

The present invention will be apparent from the following detailed description, which proceeds with reference to the accompanying drawings, wherein the same references relate to the same elements.

The invention uses at least one winding strip surrounding one another to form the disclosed broadband antenna apparatus. Its antenna feed and ground terminals can be located at arbitrary positions on the winding strips. The frequency band or bandwidth of the broadband antenna apparatus can be tuned by changing the shape of the winding strips, the number of windings, the strip width, and the interval. Moreover, at least one passive device can be added in the winding strips to adjust its frequency response. It is even possible to overlap two or more winding strip sets to change the working frequency band of the antenna, increase the bandwidth or reduce the antenna size, and reduce the production cost. In addition to satisfying the broadband requirement, the disclosed broadband antenna apparatus can even be used to receive circularly polarized signals.

To simply and clearly explain the technical features of the invention, two winding strips on a single plane are used as an example in the following embodiments. However, any person skilled in the art can understand that the antenna apparatus with at least one winding strip is also within the scope of the invention.

### FIRST EMBODIMENT

In this embodiment, two winding strips surround each other to render a broadband antenna apparatus with a broad frequency band and a small size using the electromagnetic (EM) mutual coupling effect. A skilled person can take into account the required antenna frequency, bandwidth, and field shape to change the strip shape, number of windings, strip width, and intervals, thereby adjusting the frequency band or bandwidth of the antenna apparatus.

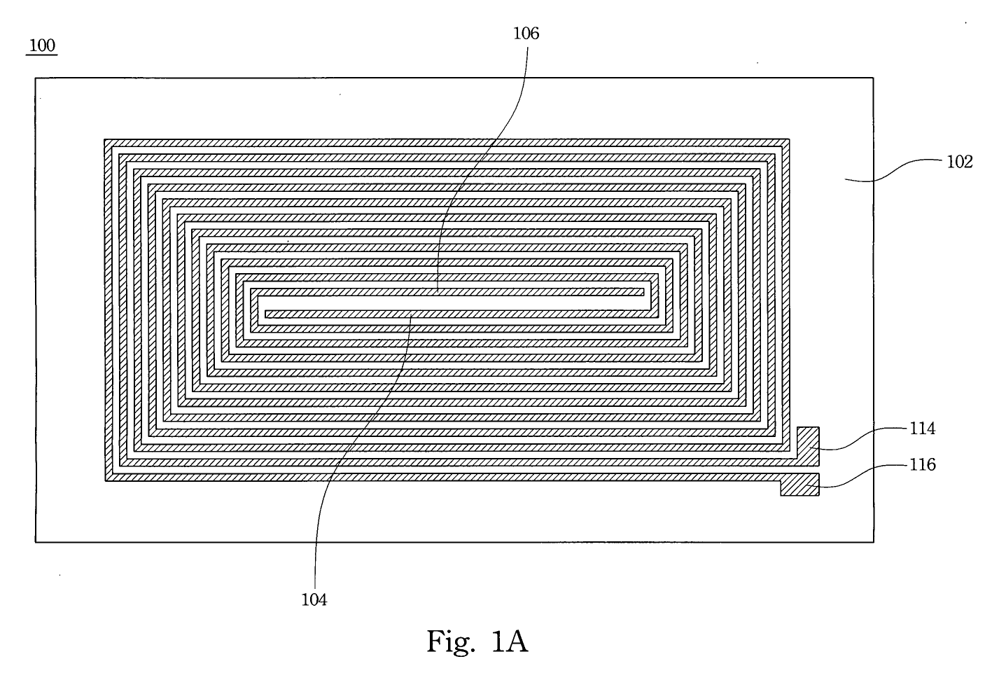

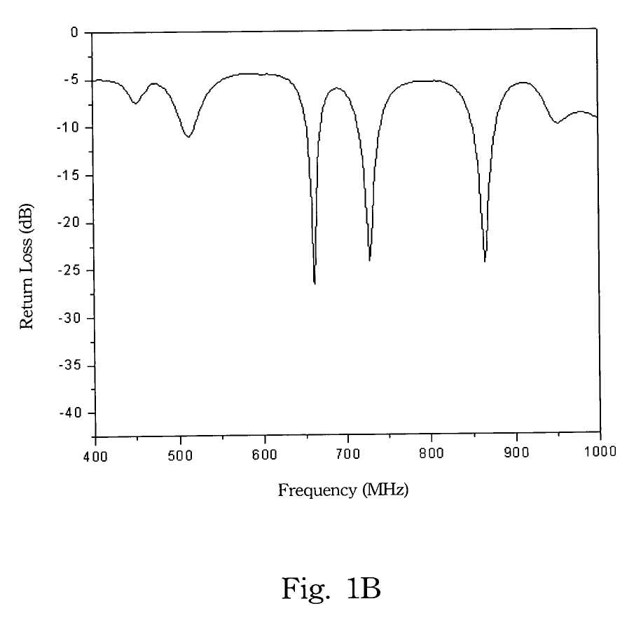

As shown in FIG. 1A, the broadband antenna apparatus 100 includes a dielectric material layer 102, and a first winding strip 104 and a second winding strip 106 disposed on the dielectric material layer 102. The first winding strip 104 and the second winding strip 106 surround each other. That is, the first winding strip 104 and the second winding strip 106 wind around each other about a common center and gradually extend out in distance. The two winding strips 104, 106 do not cross each other directly.

The shape of the first winding strip 104 and the second winding strip 106 in this embodiment is a rectangular winding strip in the counterclockwise direction from the inside out. In other embodiments of the invention, the shape of the two winding strips 104, 106 can be circular, rectangular, square, polygonal, annular, or their combinations. The winding direction can be either clockwise or counterclockwise. The above-mentioned options are selected according to the local standard where the product will be used. The options, however, are not limited to those mentioned herein.

In fact, due to the multi-path effect, a signal winding in the clockwise direction as viewed from above the broadband antenna apparatus 100 becomes counterclockwise if it is reflected by other surfaces underneath it. Therefore, it can be received by a winding strip that looks counterclockwise from below. This design of the broadband antenna apparatus 100 is suitable for signals in both clockwise and counterclockwise directions. A skilled person can decide a preferred winding direction for the strips on the dielectric material layer.

In this broadband antenna apparatus 100, the outer end 114 of the first winding strip 104 is the antenna feed for inputting or receiving signals. The outer end 116 of the second winding strip 106 is the ground terminal for grounding. However, one may choose to use the outer end 114 of the first winding strip 104 as the ground terminal and outer end 116 of the second winding strip 106 as the antenna feed. According to other embodiments of the invention, the feed and ground terminal can be located at other positions on the two winding strips 104, 106. A skilled person can decide appropriate positions on the winding strips 104, 106 as the feed and ground terminal, respectively, according to the required radiation field and effects.

The number of windings of the first winding strip 104 and the second winding strip 106 can affect the frequency band or bandwidth of the broadband antenna apparatus 100. For example, the number of windings of the winding strips 104, 106 can be 3, 4, or more. The strip widths of the first winding strip 104 and the second winding strip 106 can be the same or different. That is, the winding strips 104, 106 in the same broadband antenna apparatus 100 can have the same width, or they can be tuned to obtain better radiation field or effects. Likewise, the intervals between the winding strips 104, 106 can be the same or different at different levels of winding. A multiple winding strip with different number of windings, strip width, or intervals can render different frequency bands or bandwidths for the antenna.

The material of the dielectric material layer 102 can be a dielectric or insulating material, such as a printed circuit board (PCB), ceramic, etc. The material of the winding strips 104, 106 can be a metal, alloy, or other conductive material. For example, they can be made of copper. In this embodiment, the winding strips are further covered with another dielectric material layer the same as or different from the dielectric material layer 102. For example, the dielectric material layer of the winding strips is inserted into the dielectric material by insert molding. This does not only protect the winding strips from damages, but also reduces the circuit size of the broadband antenna apparatus 100 with the help of the dielectric material.

In this embodiment, the dielectric material layer 102 is disposed with only two winding strips 104, 106. In practice, at least one winding strip winds by itself over a single dielectric material layer 102, and some of the winding strips are selected to connect with each other. For example, if a single dielectric material layer is disposed simultaneously with three winding strips, the outermost one and the innermost one can be connected for feeding in signals. The middle winding strip is used for grounding. A skilled person can decide an appropriate number of winding strips surrounding each other over the dielectric layer and connect some of them in parallel or in series in order to obtain better broadband antenna effects.

FIG. 1B shows the frequency response for the antenna return loss of the broadband antenna apparatus 100 in FIG. 1A. The vertical axis is the antenna return loss in units of dB, and the horizontal axis is the antenna frequency in units of MHz. In this embodiment, the strip widths of the first winding strip 104 and the second winding strip 106 are both 0.4 mm. The intervals are all 0.4 mm. It should be emphasized that the sizes of the first winding strip 104 and the second winding strip 106 can be tuned to render the desired frequency resonance for different applications. As shown in FIG. 1B, the frequency range for the −5 dB return loss of the broadband antenna apparatus 100 can satisfy the requirements of the UHF ground broadcasting digital TV systems all over the world (Taiwan: 530 MHz˜602 MHz; global: 470 MHz˜860 MHz).

### SECOND EMBODIMENT

In this embodiment, the number of windings, strip width, and intervals are varied to adjust the radiation field or effects of the antenna apparatus.

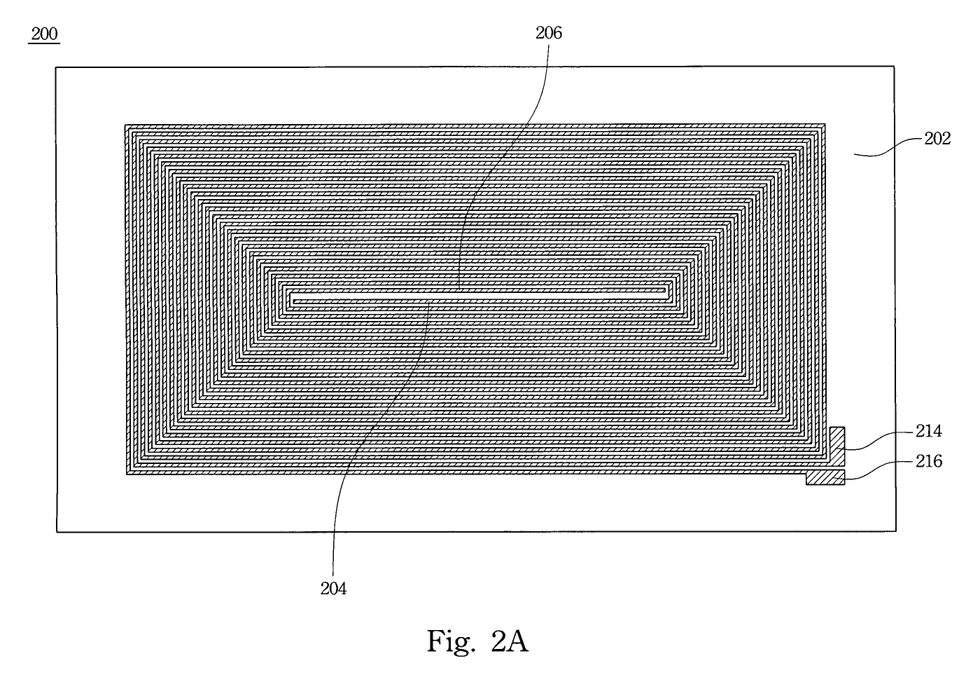

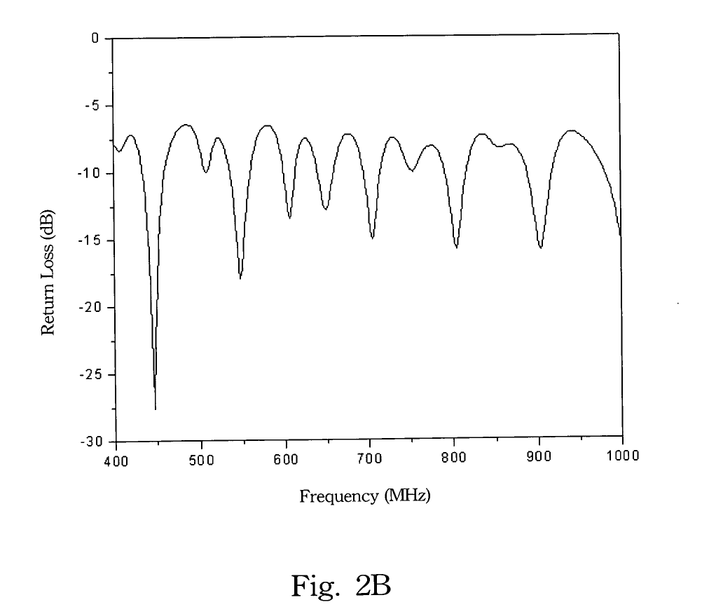

As shown in FIG. 2A, the winding strip in this embodiment has a different number of winding, strip width, and intervals from that in the first embodiment. The broadband antenna apparatus 200 includes a dielectric material layer 202, and a first winding strip 204 and a second winding strip 206 disposed on the dielectric material layer 202. The shape of the two winding strips 204, 206 are both rectangular strips winding in the counterclockwise direction from inside out. The outer end 214 of the first winding strip 204 is the antenna feed, and the outer end 216 of the second winding strip 206 is the ground terminal. The material of the dielectric material layer 202 can be a dielectric or insulating material, such as a PCB, ceramic, etc. The winding strips 204, 206 can be made of a metal, alloy, or other conductive material. For example, they can be made of copper.

FIG. 2B shows the frequency response for the antenna return loss of the broadband antenna apparatus 200 in FIG. 2A. The vertical axis is the antenna return loss in units of dB, and the horizontal axis is the antenna frequency in units of MHz. In this embodiment, the strip widths of the first winding strip 204 and the second winding strip 206 are both 0.2 mm. The intervals are all 0.2 mm. As shown in FIG. 2B, the frequency range for the −5 dB return loss of the broadband antenna apparatus 200 can satisfy the requirements of the UHF ground broadcasting digital TV systems all over the world.

### THIRD EMBODIMENT

In addition to rectangles, the winding strips of the invention can have other shapes such as circles, squares, polygons, rings, or their combinations. A skilled person can adopt different strip shapes to adjust the frequency band or bandwidth of the broadband antenna apparatus.

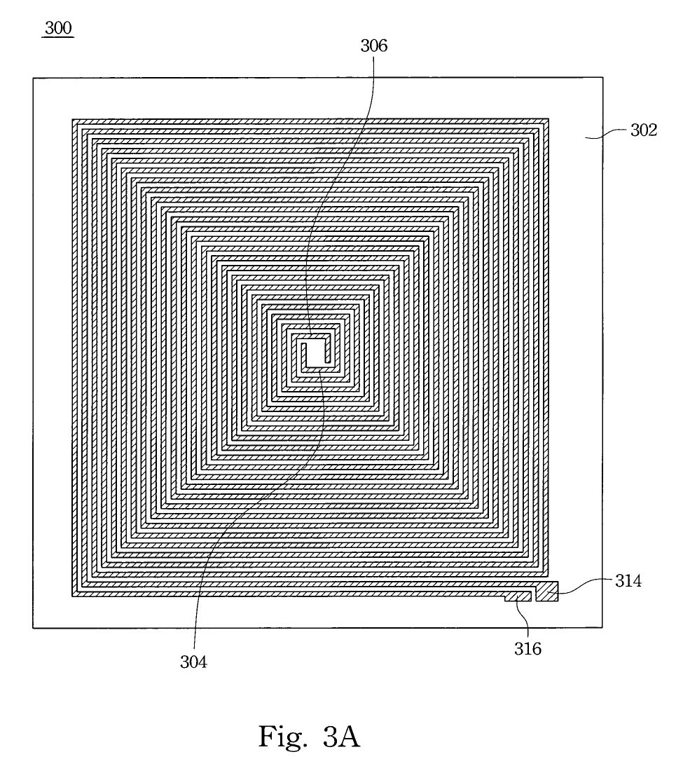

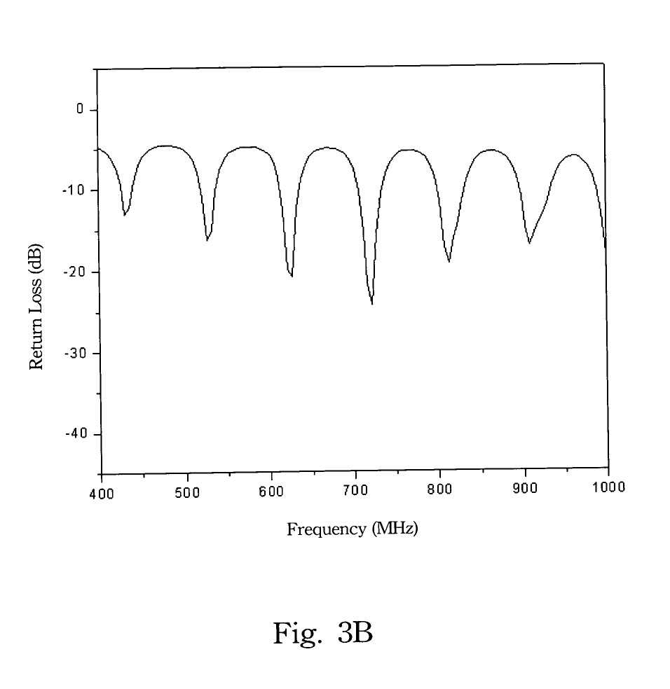

As shown in FIG. 3A, the broadband antenna apparatus 300 includes a dielectric material layer 302, and a first winding strip 304 and a second winding strip 306 disposed on the dielectric material layer 302. The first winding strip 304 and the second winding strip 306 surround each other. As shown in the drawing, the two winding strips 304, 306 are both square strips winding in the counterclockwise direction from inside out. The outer end 314 of the first winding strip 304 is the antenna feed, and the outer end 316 of the second winding strip 306 is the ground terminal. The material of the dielectric material layer 302 can be a dielectric or insulating material, such as a PCB, ceramic, etc. The winding strips 304, 306 can be made of a metal, alloy, or other conductive material. For example, they can be made of copper.

FIG. 3B shows the frequency response for the antenna return loss of the broadband antenna apparatus 300 in FIG. 3A. The vertical axis is the antenna return loss in units of dB, and the horizontal axis is the antenna frequency in units of MHz. In this embodiment, the strip widths of the first winding strip 304 and the second winding strip 306 are both 0.4 mm. The intervals are all 0.4 mm. As shown in FIG. 3B, the frequency range for the −5 dB return loss of the broadband antenna apparatus 300 can satisfy the requirements of the UHF ground broadcasting digital TV systems all over the world.

### FOURTH EMBODIMENT

In this embodiment, at least one passive device, such as a resistor, capacitor, inductor, their combination or equivalent, is connected between the two winding strips to change the frequency band or bandwidth of the broadband antenna apparatus.

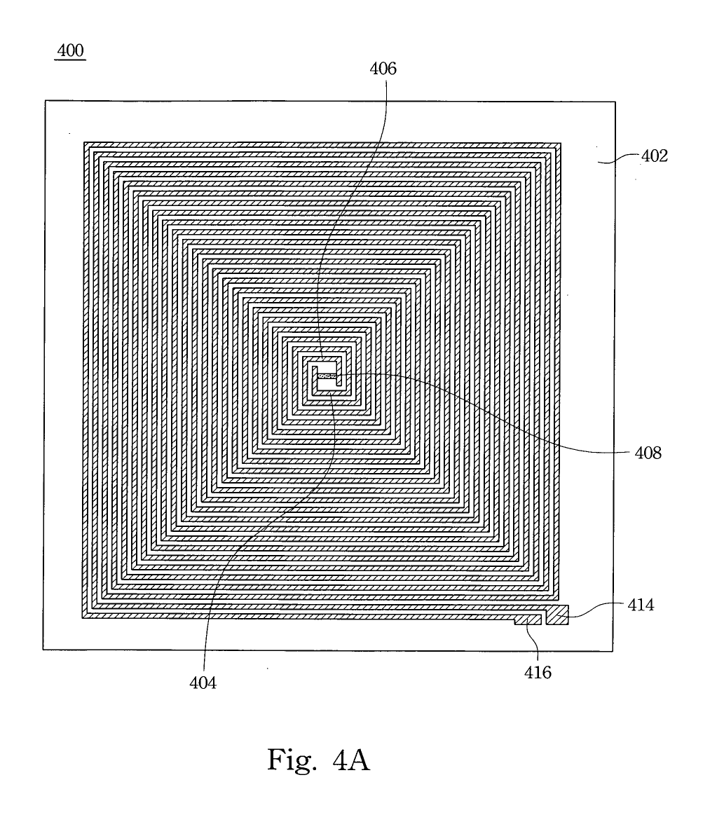

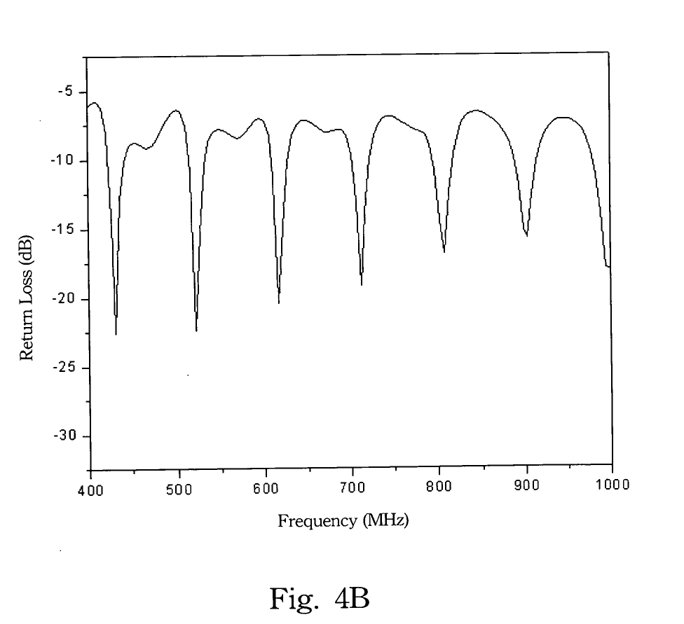

As shown in FIG. 4A, the broadband antenna apparatus 400 includes a dielectric material layer 402, and a first winding strip 404 and a second winding strip 406 disposed on the dielectric material layer 402. The first winding strip 404 and the second winding strip 406 surround each other. As shown in the drawing, the two winding strips 404, 406 are both square strips winding in the clockwise direction from inside out. The outer end 414 of the first winding strip 404 is the antenna feed, and the outer end 416 of the second winding strip 406 is the ground terminal. The material of the dielectric material layer 402 can be a dielectric or insulating material, such as a PCB, ceramic, etc. The winding strips 404, 406 can be made of a metal, alloy, or other conductive material. For example, they can be made of copper.

Moreover, a passive device is connected between the two winding strips 404, 406. For example, a resistor 408 is connected between the inner ends of the two winding strips 404, 406 to change the frequency band or bandwidth of the broadband antenna apparatus 400. In other embodiments, more than one passive device can be added. These passive devices can be of the same type (e.g., all resistors or all capacitors), of different types (e.g., resistors and capacitors), or with different electronic properties (e.g., resistors with different resistance values). Furthermore, the connection points for the passive devices between the winding strips 404, 406 are not limited to the two inner ends. Other appropriate positions can be used as well. The electronic circuits composed of different types of passive devices can be connected to the same position.

More explicitly, after a signal enters via the antenna feed, multiple paths are formed at the above-mentioned connection point, generating current paths of different lengths. The passive devices can change the input impedance-frequency response property of the antenna. In such a structure, the electrical current distribution in shorter current paths produces resonance at higher frequencies. The electrical current distribution in longer current paths produces resonance at lower frequencies. With the help of the passive devices, the entire antenna structure achieves the resonance effects in multiple frequency and broad bands.

FIG. 4B shows the frequency response for the antenna return loss of the broadband antenna apparatus 400 in FIG. 4A. The vertical axis is the antenna return loss in units of dB, and the horizontal axis is the antenna frequency in units of MHz. In this embodiment, the strip widths of the first winding strip 404 and the second winding strip 406 are both 0.4 mm. The intervals are all 0.4 mm. The passive device used herein has a resistance of 50 w. As shown in FIG. 4B, the frequency range for the −5 dB return loss of the broadband antenna apparatus 400 can satisfy the requirements of the UHF ground broadcasting digital TV systems all over the world.

### FIFTH EMBODIMENT

In this embodiment, a winding strip set is disposed on each of the two surfaces of a dielectric material layer. This can change the antenna working frequency band, increase the antenna bandwidth or reduce the antenna size, and reduce the production cost. Likewise, more than two winding strip sets can be stacked together to obtain better antenna radiation field or effects.

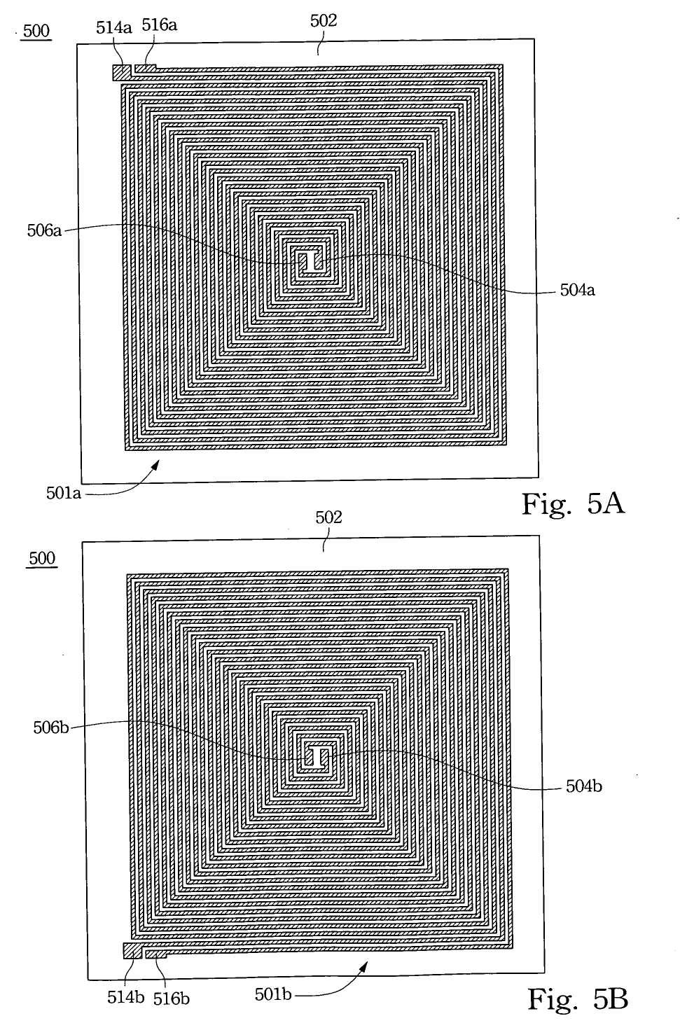

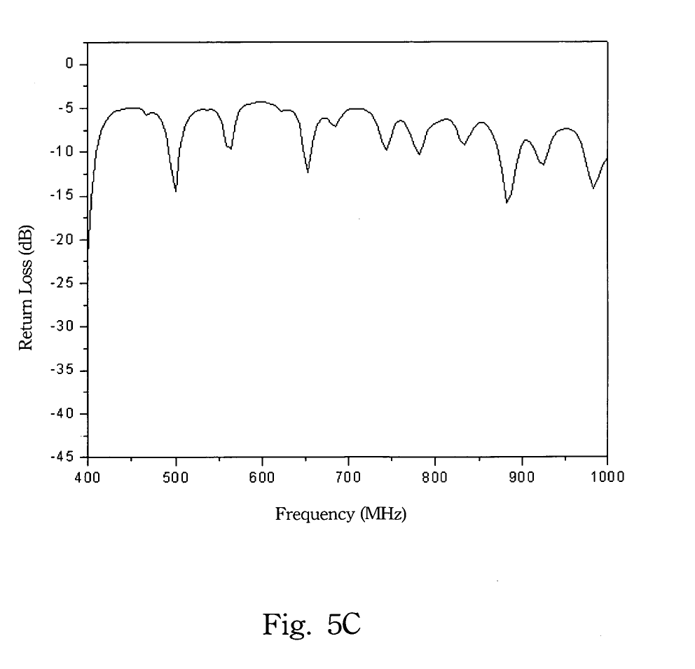

FIGS. 5A and 5B are the front and back views of the fifth embodiment. The broadband antenna apparatus 500 includes a dielectric material layer 502, and a first winding strip set 501a disposed on the front surface of the dielectric material layer 502 and a second winding strip set 501b disposed on the back surface of the dielectric material layer 502. The first winding strip set 501a has two winding strips 504a, 506a. The second winding strip set 501b has two winding strips 504b, 506b.

The winding strips 504a, 504b, 506a, 506b are square strips winding in the clockwise direction from inside out. The winding strips on the same surface (e.g., 504a, 506a or 504b, 506b) of the dielectric material layer 502 surround each other. The material of the dielectric material layer 402 can be a dielectric or insulating material, such as a PCB, ceramic, etc. The winding strips 504a, 504b, 506a, 506b can be made of a metal, alloy, or other conductive material. For example, they can be made of copper.

Moreover, the second winding strip set 501b is disposed at a position corresponding to the first winding strip set 501a. More explicitly, the winding strips 504a, 506a on the front surface of the dielectric material layer 502 are disposed right above the winding strips 504b, 506b on the back surface of the dielectric material layer 502. This changes the antenna working frequency band, increases the antenna bandwidth or reduces the antenna size, and reduces the production cost. However, in consideration of the thickness of the dielectric material layer and the signal phases, the relative positions of the two winding strip sets 501a, 501b may deviate a certain distance to render better effects.

In the first winding strip set 501a, the outer end 514a of the winding strip 504a is the feed, while the outer end 516a of the winding strip 506a is the ground terminal. In the second winding strip set 501b, the outer end 514b of the winding strip 504b is the feed, while the outer end 516b of the winding strip 506b is the ground terminal. That is, in this embodiment the outer ends 514a, 514b above and below the same position of the dielectric material layer are the feeds, while the outer ends 516a, 516b above and below another same position of the dielectric material layer are the grounds.

In other embodiments, the two winding strip sets 501a, 501b can have their own feeds and grounds, without corresponding positions or fixing them at the outer ends of the strips. Moreover, the two winding strip sets can be connected. For example, the two inner ends above and below the same position of the dielectric material layer can be connected. Some other point on one of the winding strips is then selected as the feed, while yet another point on the other uncoupled winding strip is used as the ground terminal.

A skilled person can select appropriate positions on the winding strips as the feed and ground terminal according to the design requirement. The upper and lower winding strips can be connected in parallel for simultaneously signal input or in series for one of them to receive signals. All such variations are within the scope of the invention.

As in the previous embodiments, the shapes of the winding strips 504a, 504b, 506a, 506b can be circular, rectangular, square, polygonal, annular, or their combinations. The winding direction can be clockwise or counterclockwise. The number of windings can be 3, 4, or more. The strip widths and intervals can be the same or different. A multiple winding strip with different number of windings, strip widths, or intervals can render different frequency bands or bandwidths for the antenna. Besides, this embodiment also applies to the case when there is at least one winding strip on a single plane.

For example, the winding strips in the same winding strip set 501a or 501b may have the same or different strip widths and intervals. The winding strips in different winding strip sets 501a and 501b may also have the same or different strip widths and intervals. The interval at different windings in any of the winding strips 504a, 504b, 506a, 506b can be the same as or different from the others.

FIG. 5C shows the frequency response for the antenna return loss of the broadband antenna apparatus 500 in FIG. 5A. The vertical axis is the antenna return loss in units of dB, and the horizontal axis is the antenna frequency in units of MHz. In this embodiment, the strip widths of the winding strips 504a, 504b, 504c, 504d are all 0.4 mm. The intervals are all 0.4 mm. As shown in FIG. 5C, the frequency range for the −5 dB return loss of the broadband antenna apparatus 500 can satisfy the requirements of the UHF ground broadcasting digital TV systems all over the world.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A broadband antenna apparatus, comprising:
a dielectric material layer;
a first winding strip disposed on the dielectric material layer; and
a second winding strip disposed on the dielectric material layer;
wherein the first winding strip and the second winding strip surround each other.

2. The broadband antenna apparatus of claim 1, wherein one of the first winding strip and the second winding strip has an antenna feed and the other has a ground terminal.

3. The broadband antenna apparatus of claim 2, wherein the antenna feed and the ground terminal are/are not located at the outer ends of the winding strips.

4. The broadband antenna apparatus of claim 1 further comprising at least one passive device connected in parallel or series between the first winding strip and the second winding strip.

5. The broadband antenna apparatus of claim 4, wherein the passive device is a resistor, capacitor, inductor, their combination or equivalent.

6. The broadband antenna apparatus of claim 1, wherein the strip widths of the first winding strip and the second winding strip are the same or different.

7. The broadband antenna apparatus of claim 1, wherein the intervals of the first winding strip and the second winding strip at different windings are the same or different.

8. The broadband antenna apparatus of claim 1, wherein the shapes of the first winding strip and the second winding strip are circular, square, rectangular, polygonal, annular, or their combinations.

9. The broadband antenna apparatus of claim 1, wherein the frequency band or bandwidth are dependent of the numbers of windings, shapes, and sizes of the first winding strip and the second winding strip.

10. A broadband antenna apparatus, comprising:
a dielectric material layer;
a first winding strip set having at least one winding strip surrounding one another over one surface of the dielectric material layer; and
a second winding strip set having at least one winding strip surrounding one another over the other surface of the dielectric material layer;
wherein the first winding strip set and the second winding strip set are connected or disconnected.

11. The broadband antenna apparatus of claim 10, wherein the second winding strip set is disposed corresponding to the first wind strip set to change the working frequency band and bandwidth or to reduce the size thereof.

12. The broadband antenna apparatus of claim 10, wherein at least one of the winding strips has an antenna feed while each of the other winding strips has a ground terminal.

13. The broadband antenna apparatus of claim 12, wherein the antenna feed and the ground terminal are/are not located at the outer ends of the winding strips.

14. The broadband antenna apparatus of claim 10 further comprising at least one passive device connected in parallel or series between the winding strips.

15. The broadband antenna apparatus of claim 14, wherein the passive device is a resistor, capacitor, inductor, their combination or equivalent.

16. The broadband antenna apparatus of claim 10, wherein the strip widths of the winding strips are the same or different.

17. The broadband antenna apparatus of claim 10, wherein the intervals of the winding strips in the same winding strip set at different windings are the same or different.

18. The broadband antenna apparatus of claim 10, wherein the shapes of the winding strips are circular, square, rectangular, polygonal, annular, or their combinations.

19. The broadband antenna apparatus of claim 10, wherein the frequency band or bandwidth is dependent of the numbers of windings, shapes, and sizes of the winding strips.

20. The broadband antenna apparatus of claim 10, wherein the upper or lower surface of the dielectric material layer is covered with a second dielectric material layer of the same or different material to embed the winding strips in the second dielectric material layer.
